(19) United States
(12) Patent Application Publication
(10) Pub. No.: US 2017/0219402 A1
(43) Pub. Date: Aug. 3, 2017

(54) FLOW SENSOR WITH SELF HEATING SENSOR ELEMENTS

(71) Applicant: Honeywell International Inc., Morris Plains, NJ (US)

(72) Inventors: Andrew J. Milley, Roswell, GA (US); Lamar Floyd Ricks, Lewis Center, OH (US)

(21) Appl. No.: 15/458,737

(22) PCT Filed: Sep. 16, 2015
(86) PCT No.: PCT/US2015/050399

§ 371 Date: Mar. 14, 2017

Related U.S. Application Data
(60) Provisional application No. 62/051,450, filed on Sep. 17, 2014.

(51) Int. Cl. G01F 1/69; G01F 1/684

(52) U.S. Cl. CPC G01F 1/69; G01F 1/6845

(57) ABSTRACT

Traditional flow sensors include an upstream resistive sensor element, a downstream resistive sensor element and an intervening heater resistive element. To help reduce the size and/or cost of such flow sensor, it is contemplated that the heater resistor may be eliminated. When so provided, the space required for the heater resistive element, as well as the corresponding heater control circuit, may be eliminated. This can reduce the cost, size and complexity of the flow sensor.

### TECHNICAL FIELD

The disclosure relates generally to sensors, and more particularly, to flow sensors that are configured to sense the flow of a fluid in a flow channel.

### BACKGROUND

Flow sensors are used to sense fluid flow, and in some cases, provide flow signals that can be used for instrumentation and/or control. Flow sensors are used in a wide variety of applications including industrial applications, medical applications, engine control applications, military applications, aeronautical applications, to name just a few.

### SUMMARY

The disclosure relates generally to sensors, and more particularly, to flow sensors. Traditional flow sensors include an upstream resistive sensor element, a downstream resistive sensor element and an intervening heater resistive element. To help reduce the size and/or cost of such flow sensor, it is contemplated that the heater resistor may be eliminated. When so provided, the space required for the heater resistive element, as well as the corresponding heater control circuit, may be eliminated. This can reduce the cost, size and complexity of the flow sensor.

In one example, a flow sensor may be provided that has an upstream self heating sensor element and a downstream self heating sensor element, with no intervening heater element. In some cases, the upstream resistive element and the downstream resistive element are operatively connected in a bridge circuit. The bridge circuit may be configured to supply a current to each of the upstream resistive element and the downstream resistive element that causes resistive heating such that both the upstream resistive element and the downstream resistive element are heated above the ambient temperature of the fluid flowing through a flow channel. When fluid flow is present in a flow channel, the fluid flow causes the temperature of the upstream resistive element to be lower than the temperature of the downstream resistive element. The difference in temperature causes an imbalance in the bridge circuit that is related to the flow rate of the fluid flowing though the flow channel.

The above summary is not intended to describe each and every disclosed illustrative example or every implementation of the disclosure. The Description that follows more particularly exemplifies various illustrative embodiments.

### BRIEF DESCRIPTION OF THE FIGURES

The following description should be read with reference to the drawings. The drawings, which are not necessarily to scale, depict selected illustrative embodiments and are not intended to limit the scope of the disclosure. The disclosure may be more completely understood in consideration of the following description of various illustrative embodiments in connection with the accompanying drawings, in which:

FIG. 1 schematic cross-sectional view of an example flow sensing device;

FIG. 2 is a schematic circuit diagram of an example prior art flow sensor;

FIG. 3 is a top view of an example prior art flow sensor die;

FIG. 4 is a schematic circuit diagram of an illustrative flow sensor with one or more self heating resistive elements;

FIG. 5 is a top view of an illustrative flow sensor die with one or more self heating resistive elements;

FIG. 6 is a chart showing sensitivity versus flow rate of a prior art flow sensor die such as shown in FIG. 3 at various heater voltages; and

FIG. 7 is a chart showing sensitivity versus flow rate of a flow sensor die with one or more self heating resistive elements such as shown in FIG. 5 at various bridge supply voltages.

### DESCRIPTION

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives that may be utilized.

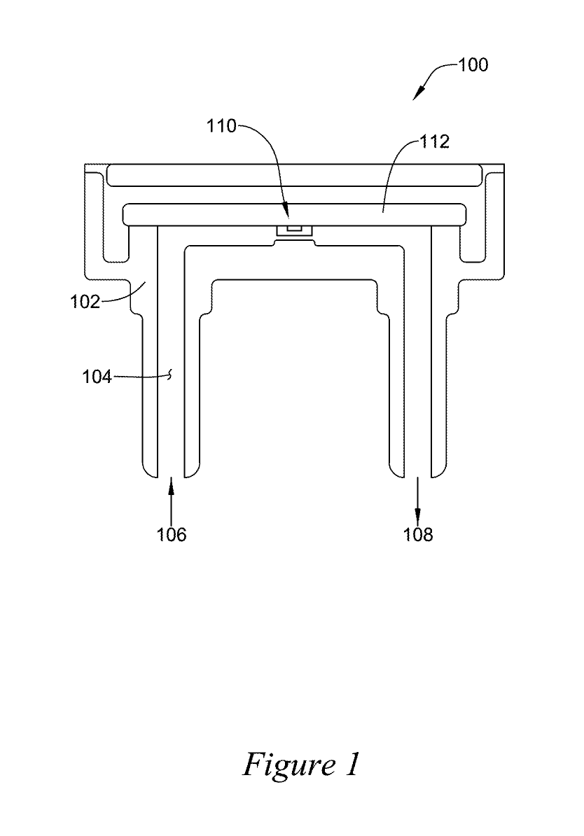

FIG. 1 is a schematic cross-sectional view of an example flow sensing device 100. The illustrative flow sensing device 100 includes a flow sensing device body 102 that defines a flow channel 104 having first end 106 and a second end 108. A fluid may flow through the flow channel 104 from for example the first end 106 to the second end 108 and past a flow sensor 110. The flow sensor 110 may sense the flow of the fluid passing over the flow sensor 110, and provide one or more output signals indicative of that flow. In some cases, the flow sensor 110 may provide one or more output signals that identity the flow rate of the fluid passing over the flow sensor 110.

While not required, the flow sensor 110 may include a flow senor die that is mounted to a substrate 112. The substrate 112 may be mounted in the flow sensing device body 102. In some cases, some of the support circuitry for the flow sensor die may be located on the substrate 112 and/or may be located outside of the flow sensing device 100 altogether (e.g. located in a device that uses the output of the flow sensing device 100). FIG. 1 shows one example configuration of a flow sensing device. It should be recognized that such flow sensor devices can and do assume a wide variety of different configurations, depending on the application.

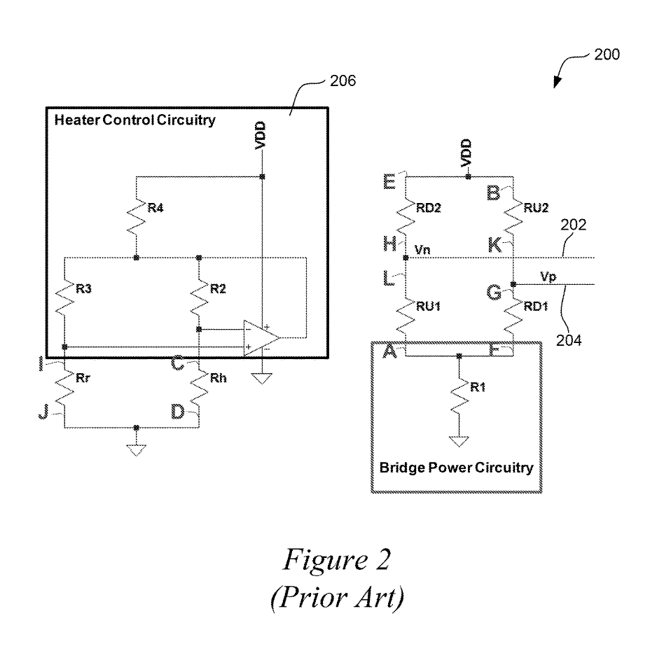

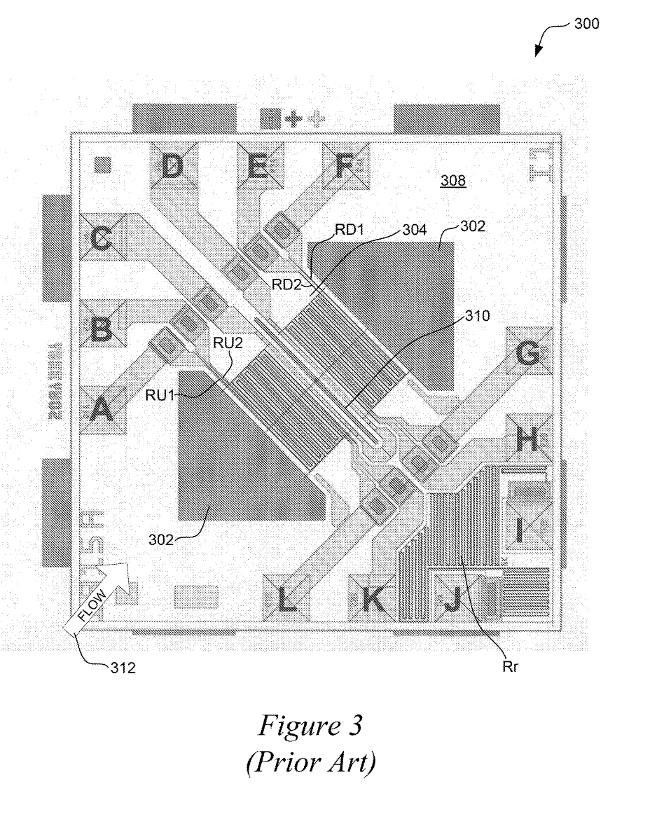

FIG. 2 is a schematic circuit diagram of an example prior art flow sensor 200. The example flow sensor 200 includes two upstream resistive elements RU1 and RU2 and two downstream resistive elements RD1 and RD2 connected in a full Wheatstone bridge configuration. The two upstream resistive elements RU1 and RU2 are positioned upstream of the two downstream resistive elements RD1 and RD2 within a flow channel, as best shown in FIG. 3. In the example shown, RU1 is connected between nodes L and A, RU2 is connected between nodes B and K, RD1 is connected between nodes G and F, and RD2 is connected between nodes E and H. A differential output of the bridge is taken between nodes Vn 202 and Vp 204. During use, a supply voltage, such as 2.4 volts, is provided to nodes E and B, and ground is connected to nodes A and F, either directly or through a resistor R1.

The example flow sensor 200 of FIG. 2 also includes a heater resistor Rh. Heater resistor Rh is connected between nodes C and D as shown. The heater resistor Rh is physically positioned between the upstream resistive elements RU1 and RU2 and the downstream resistive elements RD1 and RD2, as best shown in FIG. 3. The heater resistor Rh is heated by a heater control circuit 206. The heater resistor Rh typically has a resistance that is significantly lower than the nominal resistance of the resistive elements RU1, RU2, RD1 and RD2, such as 200 ohms. Resistive elements RU1, RU2, RD1 and RD2 may have a nominal resistance of, for example, 2.5 K ohms).

When no flow is present, the heater resistor Rh heats the fluid in the flow channel, which through conduction and convection, evenly heats the resistive elements RU1, RU2, RD1 and RD2. Since all of the resistive elements RU1, RU2, RD1 and RD2 are heated evenly, the bridge circuit remains in balance. However, when flow is present, the upstream resistive elements RU1 and RU2 are lowered in temperature relative to the downstream resistive elements RD1 and RD2. As the flow rate of the fluid in the flow channel increases, the difference in temperature between the upstream resistive elements RU1 and RU2 and the downstream resistive elements RD1 and RD2 increases. This difference in temperature causes the downstream resistive elements RD1 and RD2 is have a higher resistance than the upstream resistive elements RU1 and RU2 (assuming a positive temperature coefficient), thereby causing the bridge to become imbalanced. This imbalance produces a differential output signal between Vp 204 and Vn 202 that increases with flow rate and is monotonic with flow rate. In some cases, a sensing circuit (not shown) may receive Vp 204 and Vn 202, and may perform some compensation and/or linearization before providing a flow sensor output signal, if desired.

The example flow sensor 200 also includes a temperature reference resistor Rr. Temperature referenced resistor Rr is connected between nodes I and J. The reference resistor Rr may have a nominal resistance of, say, 4 K ohms. The heater control circuit 206 controls the temperature of the heater resistor Rh to be above a reference (or ambient) temperature of the fluid sensed by reference resistor Rr. In most cases, it is desirable to heat the heater resistor Rh some amount (e.g. 200 degrees F.) above the ambient temperature of the fluid in the flow channel to increase the signal-to-noise ratio of the flow sensor.

FIG. 3 is a top view of an example prior art flow sensor die 300. The flow sensor die has an etched cavity 302 that extends under a membrane 304. The etched cavity 302 helps to thermally isolate the membrane 304 from the substrate 308 of the flow sensor die 300. The example flow sensor die 300 includes a slit 310 through the membrane 304 that extends transverse across the membrane 304. During use, the flow sensor die 300 is positioned in a flow channel.

To help explain the operation of the flow sensor die 300, it is assumed that fluid flows over the flow sensor die 300 in the direction indicated by arrow 312. When so provided, the two upstream resistive elements RU1 and RU2 are positioned on the membrane 304 upstream of the slit 310, and the two downstream resistive elements RD1 and RD2 are positioned on the membrane 304 downstream of the slit 310. The heater resistor Rh is positioned between the upstream resistive elements RU1 and RU2 and the downstream resistive elements RD1 and RD2. In the example shown, the heater resistor Rh includes two legs connected in series, with one leg positioned on either side of the slit 310. The example flow sensor die 300 is one possible layout of the schematic circuit diagram shown in FIG. 2, with the corresponding nodes indicated (A-L). The example flow sensor die 300 does not include the heater control circuit 206, the connection between nodes H-L, the connection between nodes K-G, the connection between nodes E-B, or the connection between A-F. This example flow sensor die 300 is considered a test die, and these connections are intended to be made external to the flow sensor die 300. However, they could be made on the flow sensor die 300 if desired.

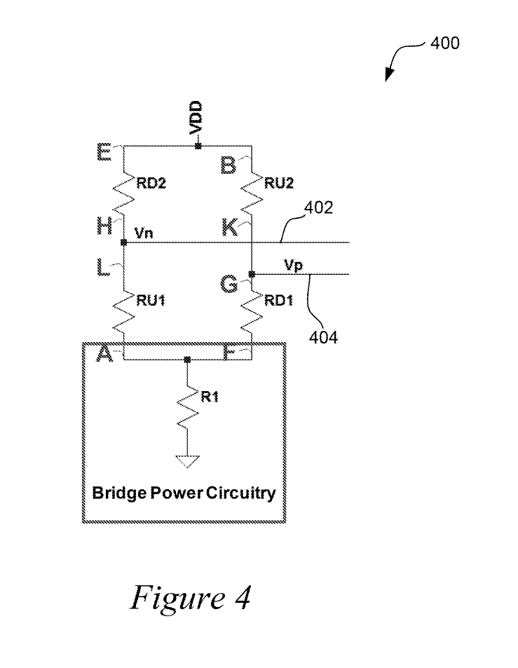

To help reduce the size and/or cost of the prior art flow sensor die 300 discussed above, it is contemplated that the heater resistor Rh may be eliminated. When so provided, the space required for the heater resistor Rh, as well as the heater control circuit 306, may be eliminated. FIG. 4 is a schematic circuit diagram of an illustrative flow sensor 400 with this modification. The flow sensor 400 eliminates the heater resistor Rh and the corresponding heater control circuit discussed above. In order to provide the necessary heat to make the flow measurement, it is contemplated that one or more of the resistive elements RU1, RU2, RD1 and RD2 may be self heating. That is, one or more resistive elements RU1, RU2, RD1 and RD2 may not only heat the fluid but also sense the temperature of the fluid. In one example, all of the resistive elements RU1, RU2, RD1 and RD2 are self heating (i.e. heat and sense). In other instances, only one upstream resistive element RU1 or RU2 may be self heating, both upstream resistive elements RU1 and RU2 may be self heating, only one upstream resistive element RU1 or RU2 and only one downstream resistive element RD1 or RD2 may be self heating, or any other combination of resistive elements may be self heating so long as at least one upstream resistive element is self heating. In some cases, only one upstream resistive element and only one downstream resistive element is provided, rather than two.

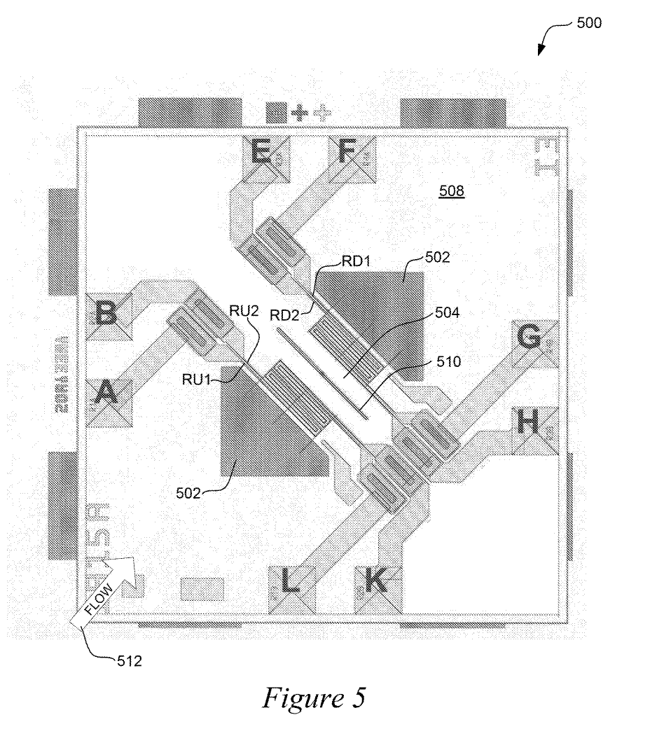

In the example shown, the illustrative flow sensor 400 includes two upstream resistive elements RU1 and RU2 and two downstream resistive elements RD1 and RD2 connected in a full Wheatstone bridge configuration. It is contemplated, however, that only one upstream resistive element RU1 and one downstream resistive element RD2 may be provided, which in some cases, can be connected in a half-bridge or other configuration. In the example shown in FIG. 4, the two upstream resistive elements RU1 and RU2 are positioned upstream of the two downstream resistive elements RD1 and RD2 within a flow channel, as best shown in FIG. 5. RU1 is connected between nodes L and A, RU2 is connected between nodes B and K, RD1 is connected between nodes G and F, and RD2 is connected between nodes E and H. A differential output of the bridge is taken between nodes Vn 402 and Vp 404. During use, a supply voltage, such as 2.4 volts, may be provided to nodes E and B, and ground may be connected to nodes A and F, either directly or through a resistor R1.

In most cases, resistive elements RU1, RU2, RD1 and RD2 have substantially the same temperature coefficient (positive or negative). Substantially the same here means plus or minus ten (10) percent. In some cases, resistive elements RU1, RU2, RD1 and RD2 have temperature coefficients that are within 1 percent or less of each other. Also, resistive elements RU1, RU2, RD1 and RD2 may have substantially the same nominal resistance, such as about 500 ohms. In some cases, resistive elements RU1, RU2, RD1 and RD2 may have nominal resistance valves that are within twenty (20) percent, ten (10) percent, five (5) percent, or one (1) percent or less of each other. In some cases, the resistive elements RU1, RU2, RD1 and RD2 may be formed from a common set of one or more layers. Notably, in FIG. 5, the two upstream resistive elements RU1 and RU2 and the two downstream resistive elements RD1 and RD2 are not separated by an intervening heater resistor Rh, and in particular, a heater resistor Rh that has a significantly lower resistance than the resistance of the resistive elements. Significantly less means at least twenty (20) percent less.

For discussion purposes, it is assumed that all of the resistive elements RU1, RU2, RD1 and RD2 are self heating. When no flow is present, the resistive elements RU1, RU2, RD1 and RD2 heat the fluid in the flow channel, which through conduction and convection, evenly heats the resistive elements RU1, RU2, RD1 and RD2. Since all of the resistive elements RU1, RU2, RD1 and RD2 are heated evenly, the bridge circuit remains in balance. However, when flow is present, the upstream resistive elements RU1 and RU2 are lowered in temperature relative to the downstream resistive elements RD1 and RD2. As the flow rate of the fluid in the flow channel increases, the difference in temperature between the upstream resistive elements RU1 and RU2 and the downstream resistive elements RD1 and RD2 increases. This difference in temperature causes the downstream resistive elements RD1 and RD2 is have a higher resistance than the upstream resistive elements RU1 and RU2 (assuming a positive temperature coefficient), thereby causing the bridge to become imbalanced. This imbalance produces a differential output signal between Vp 404 and Vn 402 that increases with flow rate and is monotonic with flow rate. In some cases, a sensing circuit (not shown) may receive Vp 404 and Vn 402, and may perform some compensation and/or linearization before providing a flow sensor output signal, if desired.

FIG. 5 is a top view of an illustrative flow sensor die 500. The illustrative flow sensor die has an etched cavity 502 that extends under a membrane 504. The etched cavity 502 helps to thermally isolate the membrane 504 from the substrate 508 of the flow sensor die 500. The illustrative flow sensor die 500 includes a slit 510 that extends transverse across the membrane 304, but this is not required. During use, the illustrative flow sensor die 500 is positioned in a flow channel.

To help explain the operation of the flow sensor die 500, it is assumed that fluid flows over the flow sensor die 500 in the direction indicated by arrow 512. When so provided, the two upstream resistive elements RU1 and RU2 are positioned on the membrane 504 upstream of the slit 510, and the two downstream resistive elements RD1 and RD2 are positioned on the membrane 504 downstream of the slit 510. Note, there is no separate heater resistor Rh positioned between the upstream resistive elements RU1 and RU2 and the downstream resistive elements RD1 and RD2. The illustrative flow sensor die 500 shown in FIG. 5 is one possible layout of the schematic circuit diagram shown in FIG. 4, with the corresponding nodes indicated (A-B, E-H and K-L). The illustrative flow sensor die 500 also does not include heater control circuitry.

The illustrative flow sensor die 500 does not include the connection between nodes H-L, the connection between nodes K-G, the connection between nodes E-B, or the connection between A-F. This flow sensor die 500 is considered a test die, and these connections are intended to be made external to the flow sensor die 300 itself In some cases, these connections may be made on the flow sensor die 500. To further reduce the size of the membrane 504, and thus the flow sensor die 500, it is contemplated that the two upstream resistive elements RU1 and RU2 may be moved closer to the two downstream resistive elements RD1 and RD2 that is shown in FIG. 5.

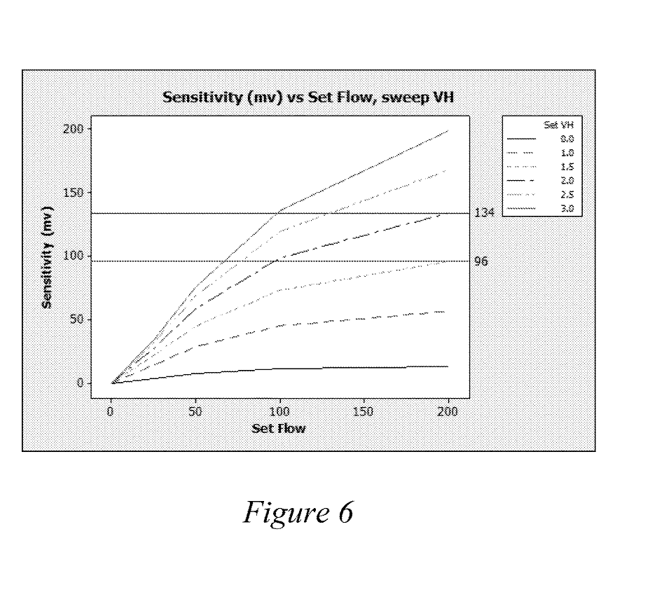

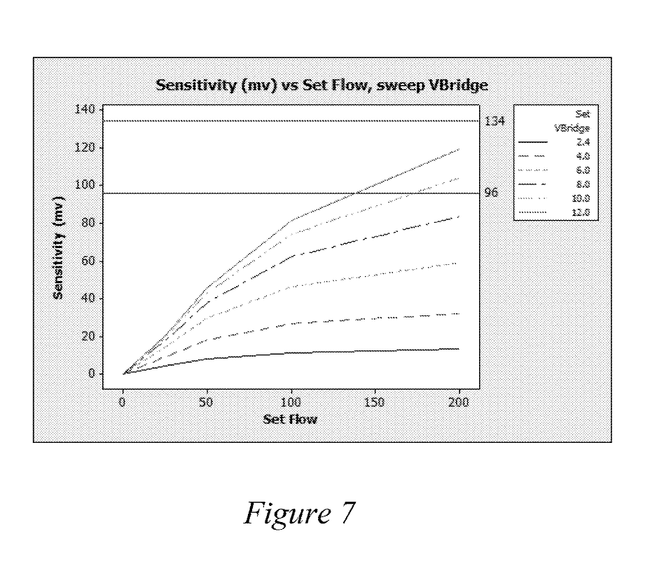

FIG. 6 is a chart showing sensitivity (differential bridge output) versus flow rate for a prior art flow sensor die such as that shown in FIG. 3 at various heater voltages. The bridge voltage was at 2.4 volts. As can be seen, the sensitivity at heater voltages of 1.5-2.0 volts produces a sensitivity (differential bridge output) in the range of about 96-134 mv at flow rate of about 200. FIG. 7 is a chart showing sensitivity (differential bridge output) versus flow rate of a flow sensor die with four self heating resistive elements RU1, RU2, RD1 and RD2 such as shown in FIG. 5 at various bridge supply voltages. As can be seen, a similar sensitivity (differential bridge output) can be achieved to that shown in FIG. 6 by increasing the bridge voltage (VDD) to about 10-14 volts. Notably, the chart shown in FIG. 7 assumes that the resistance of the resistive elements RU1, RU2, RD1 and RD2 is the same as the resistance of the resistive elements RU1, RU2, RD1 and RD2 for the chart of FIG. 6 (2.4 K ohms). To reduce the bridge voltage that is required in FIG. 7, it is contemplated that the resistance of the resistive elements RU1, RU2, RD1 and RD2 of FIG. 4-5 may be reduced, such to 500 ohms (e.g. 300-900 ohms). This may allow each of the resistive elements RU1, RU2, RD1 and RD2 to produce a similar amount of heat but at a lower bridge voltage. It is believed that this should result in a similar sensitivity (differential bridge output) to that shown in FIG. 6 and at a similar bridge voltage (e.g. 2.4 volts).

The disclosure should not be considered limited to the particular examples described above. Various modifications, equivalent processes, as well as numerous structures to which the disclosure can be applicable will be readily apparent to those of skill in the art upon review of the instant specification.

1.-15. (canceled)

16. A flow sensor for sensing a fluid flow rate through a flow channel, the flow sensor comprising:
an upstream resistive element having a first resistance that changes with temperature;
a downstream resistive element having a second resistance that changes with temperature, wherein the downstream resistive element is situated downstream of the upstream resistive element in the flow channel;
the upstream resistive element and the downstream resistive element are operatively connected in a bridge circuit, wherein the bridge circuit is configured to supply a current to each of the upstream resistive element and the downstream resistive element, wherein the current causes resistive heating in both the upstream resistive element and the downstream resistive element such that both the upstream resistive element and the downstream resistive element are heated above the ambient temperature of the fluid flowing through the flow channel, wherein fluid flow through the flow channel causing the temperature of the upstream resistive element to be lower than the temperature of the downstream resistive element; and
wherein a difference in temperature between the upstream resistive element and the downstream resistive element causes an imbalance in the bridge circuit that is related to the fluid flow rate of the fluid flowing though the flow channel.

17. The flow sensor of claim 16, wherein the first resistance is substantially the same as the second resistance when the fluid flow rate is at zero.

18. The flow sensor of claim 16, wherein the upstream resistive element has a first temperature coefficient, and the downstream resistive element has a second temperature coefficient, wherein the first temperature coefficient is substantially the same as the second temperature coefficient.

19. The flow sensor of claim 16, wherein the upstream resistive element and the downstream resistive element are formed from a common set of one or more layers.

20. The flow sensor of claim 16, wherein the upstream resistive element and the downstream resistive element are not separated by an intervening heater element that has a substantially lower resistance than the first resistance.

21. The flow sensor of claim 16, wherein the upstream resistive element and the downstream resistive element are not separated by an intervening heater element.

22. A flow sensor device comprising:
a substrate;
a membrane suspended by the substrate;
an upstream resistive element situated on the membrane;
a downstream resistive element situated on the membrane adjacent the upstream resistive element, with no intervening heater element positioned between the upstream resistive element and the downstream resistive element;
a first upstream node coupled to a first end of the upstream resistive element and a second upstream node coupled to a second end of the upstream resistive element;
a first downstream node coupled to a first end of the downstream resistive element and a second downstream node coupled to a second end of the downstream resistive element;
wherein the upstream resistive element has an electrical resistance between the first upstream node and the second upstream node, and the downstream resistive element has an electrical resistance between the first downstream node and the second downstream node; and
wherein the resistance of the upstream resistive element is within 20 percent or less of the resistance of the downstream resistive element when the upstream resistive element is at the same temperature as the downstream resistive element.

23. The flow sensor device of claim 22, wherein the resistance of the upstream resistive element is within 10 percent or less of the resistance of the downstream resistive element when the upstream resistive element is at the same temperature as the downstream resistive element.

24. The flow sensor device of claim 22, wherein the resistance of the upstream resistive element is within 1 percent or less of the resistance of the downstream resistive element when the upstream resistive element is at the same temperature as the downstream resistive element.

25. The flow sensor device of claim 22, wherein the upstream resistive element has a first temperature coefficient, and the downstream resistive element has a second temperature coefficient, wherein the first temperature coefficient is the same as the second temperature coefficient.

26. The flow sensor device of claim 22, wherein the upstream resistive element and the downstream resistive element are formed from a common set of one or more layers on the membrane.

27. A flow sensor die comprising:
a substrate;
a membrane suspended by the substrate;
an upstream resistive element situated on the membrane;
a downstream resistive element situated on the membrane adjacent the upstream resistive element, with no intervening heater element positioned between the upstream resistive element and the downstream resistive element.

28. The flow sensor die of claim 27, further comprising:
a slit formed through the membrane between the upstream resistive element and the downstream resistive element.

29. The flow sensor die of claim 27, wherein the upstream resistive element and the downstream resistive element are spaced substantially the same distance from the slit.

30. The flow sensor die of claim 27, wherein the flow sensor die is absent a heater control circuit.

31. The flow sensor die of claim 27, comprising two upstream resistive elements on the membrane, and two downstream resistive elements on the membrane.

32. The flow sensor die of claim 27, wherein the upstream resistive element and the downstream resistive element are connected in a Wheatstone bridge configuration.

33. The flow sensor die of claim 27, wherein the upstream resistive element and the downstream resistive element have substantially the same resistance.

34. The flow sensor die of claim 27, wherein the upstream resistive element and the downstream resistive element have substantially the same temperature coefficient.

35. The flow sensor die of claim 27, wherein the upstream resistive element and the downstream resistive element have a resistance in the range of 300-900 ohms.
